(19) United States
(12) Patent Application Publication
(10) Pub. No.: US 2012/0111503 A1
(43) Pub. Date: May 10, 2012

(54) HEATING COIL WELDING FITTING

(75) Inventor: Joerg Wermelinger, Schaffhausen (CH)

(73) Assignee: GEORG FISCHER ROHRLEITUNGSSYSTEME AG, Schaffhausen (CH)

(21) Appl. No.: 13/289,198

(22) Filed: Nov. 4, 2011

(30) Foreign Application Priority Data
Nov. 4, 2010 (EP) 10 189 916.9

(51) Int. Cl. B32B 37/06

(52) U.S. Cl. 156/379.6

(57) ABSTRACT

A heating coil welding fitting comprising a cylindrical coupling body for welding pipelines made of thermoplastics or other weldable plastics, containing at least two heating wire windings, each with a plurality of turns which are at any desired distance from one another, and contacts for feeding the electric current, wherein the heating wire winding is wavy, preferably sinusoidal, and the coupling can be deformed as a result.

### BACKGROUND OF THE INVENTION

The invention relates to heating coil welding fittings comprising a cylindrical coupling body for welding pipelines made of thermoplastics or other weldable plastics, containing at least two heating wire windings, each with a plurality of turns which are at any desired distance from one another, and contacts for feeding the electric current.

For reasons of weight and corrosion, pipelines made of thermoplastics have been repeatedly used in pipeline construction mainly in recent years, specifically for the construction of pipeline networks for gas and water supply and for the delivery of air, waste water or even chemicals. The pipelines used are usually made of pressure-resistant plastic. To connect such pipelines, electric welding sleeves which have two heating coil welding zones are often used for reasons of efficiency. The larger the conduit diameter of the pipelines to be connected, the greater is the effort required for connecting the individual pipeline components. Since in large conduit cross sections the wall thicknesses are correspondingly large and the production tolerances of the pipelines and of the electric welding sleeves at large diameters result in a relatively large gap formation between the pipe outside diameter and the inside diameter of the electric welding sleeve when the components are brought together, the preconditions for optimum welding do not exist. That is to say that, at a large gap between the outside diameter of the pipe and the inside diameter of the electric welding sleeve, a long weld time is required and in addition a large quantity of electrical energy is required just to fill the gap with the heated and therefore liquefied plastic and in order to achieve welding. In order to readily utilize the fed electrical energy in an appropriate manner, good heat transfer and as large a contact area as possible should be ensured; otherwise no welded joint corresponding to the requirements in pipeline construction can be achieved. Furthermore, in the case of a large gap and a long heating time, there is the risk of a wire emerging, which can lead to local overheating and to the formation of fumes and odours. The emergence of a wire means that, due to the heating of the wire, the wire expands, that is to say it becomes longer and takes up more space. Since the wire selects the path of least resistance, it expands in the direction in which it has less plastic to displace and therefore in the direction of the inside diameter of the electric welding sleeve. Since the linear expansion of the heating wire is now not distributed regularly but rather is concentrated at one location, the wire often emerges due to the increased space required by the wire.

DE 43 32 196 C2 describes a welding sleeve which enables a welding sleeve to be welded to a pipeline in as uniform a manner as possible. The welding sleeve is composed of a sleeve body and an inner sleeve part which has grooves for accommodating the resistance wire. In each case at the start and at the end of each heating zone, the pitch of the groove and thus the winding spacing is less than in the centre region of a heating zone. As a result of the greater density of the winding at the start and at the end of each heating zone, a greater heating capacity is obtained in the more closely wound regions, thereby compensating for the greater heat losses occurring in these regions, such that a uniform welded joint is achieved in the entire region of the heating zone.

JP 11294673 A discloses an electric welding sleeve in which the heating wire has only one winding along the inner circumference of the electric welding sleeve, and said heating wire, due to its axial spread, extends over a relatively wide part of the electric welding sleeve and in each case has cold zones in the centre and at the two ends of the electric welding sleeve.

In the prior art cited above, the electric welding sleeves permit no deformation at all, i.e. the electric welding sleeves cannot be constricted or compressed, and as a result the gap between electric welding sleeve and pipeline remains, which, at a corresponding gap width, can in turn result in poor heat transfer and thus in poor welding of the electric welding sleeve to the respective pipeline components.

Community Design 000926357-0001 represents a pipe joint part which is of conical design and has wedge-shaped incisions along the circumference in order to adapt it to the conditions. The heating winding runs around the wedge-shaped incisions.

The disadvantage of such a pipe joint part is that the tightness of a pipe joint is no longer provided for due to the wedge-shaped incisions, a factor which is decisive for a pipeline system.

Proceeding from this prior art, the object of the invention is to specify a heating coil welding fitting which can be deformed or compressed and as a result the gap between pipe/butt welding fitting and heating coil welding fitting can be reduced or entirely eliminated; in addition, the risk of a wire emerging is to be reduced and the energy demand is to be decreased.

### SUMMARY OF THE INVENTION

This object is achieved according to the invention in that the heating wire winding is wavy, preferably sinusoidal, and the fitting can be deformed as a result. As a result of the wavy course, the heating coil welding fitting can be elastically deformed and the sleeve or the nipple can be compressed as a result. This enables the electric welding sleeve to be compressed by a clamping tool, said electric welding sleeve, for installation reasons, having a larger inside diameter than the outside diameter of the pipe to be inserted. One possibility for compressing an electric welding sleeve consists in contracting the sleeve by means of a clamping set placed around the circumference of the electric welding sleeve until the inside diameter of the sleeve and the outside diameter of the pipeline bear against one another and in subsequently welding them. Optimum heat transfer from the heating element or the heating coil welding sleeve or of the nipple to the pipeline is made possible by the two diameters bearing against one another. Thus the heating times are considerably shortened and the requisite energy can be reduced, which is finally reflected in savings in the assembly costs of the pipelines.

The pitch of the wavy heating wire winding or the distances between the turns can be constant as well as variable; they are matched to the pipe dimensions and the material. In the case of a variable course, the pitch and consequently the distances between the turns are usually smaller at the start and at the end of the heating zone in order to increase the heating capacity in the outer regions of the heating coil welding fitting, although other pitches are also conceivable. The pitch of the winding runs in the direction of the longitudinal axis of the attached or welded-on pipeline sections. Heating coil welding fittings such as sleeves and nipples which bring together more than two pipeline sections, for example a Y-shaped or T-shaped connection element, are also conceivable.

To ensure that the inserted pipeline sections are correctly positioned in the heating coil welding fitting, the sleeve and also the nipple can have a stop, up to which the pipeline sections must be pushed. When the pipeline component is positioned at the stop, this ensures that the pipeline sections have been pushed sufficiently far into the sleeve or over the nipple.

This type of heating coil welding is especially suitable for pipe diameters over 250 mm, since it is particularly the case at large diameters that the gap between fitting and pipe becomes increasingly larger and welding is very time-consuming as a result, and the welding time can be reduced by such an embodiment of the heating coil welding fitting.

The deflection or the amplitude of the heating wire winding should likewise be matched individually to the size of the pipeline, the deflection not exceeding the value of 10 mm. In the normal case, six to twelve cycles of the wavy wire are provided along a turn of the heating wire winding; the number of cycles likewise depends on the pipe diameter.

The amplitude or the deflection and the number and length of the cycles remain constant during the course of each winding along the circumference.

One possibility for the design of the wavy winding is to produce a continuous or curved heating wire winding; that is to say the changes in direction of the wire are produced by curves.

Alternatively, the heating wire winding can be wound on in a zigzag-like or discontinuous manner along the diameter; in this variant, the changes in direction of the wire are abrupt, and the wire is in each case deflected in the other direction at one point.

As a rule, such heating wire windings are incorporated into electric welding sleeves and are usually inserted into the plastic very close to the edge of the electric welding sleeve at the inside diameter; the wall thickness of the electric welding sleeve between the heating wire winding and the pipeline component is therefore small, and thus good heat flow to the pipeline component can be achieved.

However, the invention is additionally distinguished by the fact that the heating wire winding can also be attached to the outside diameter of a nipple and as a result pipeline sections can also be accommodated over their inside diameter.

### BRIEF DESCRIPTION OF THE DRAWINGS

An exemplary embodiment of the invention is described with reference to the figures, the invention not being restricted just to the exemplary embodiment. In the drawing:

FIG. 1 shows a longitudinal section of an electric welding sleeve having two different wavy heating wire windings,

FIG. 2 shows cycles of the wavy heating wire winding which run in a continuous and discontinuous manner, respectively, and

FIG. 3 shows wavy heating wire windings on the outside diameter of a nipple.

### DETAILED DESCRIPTION

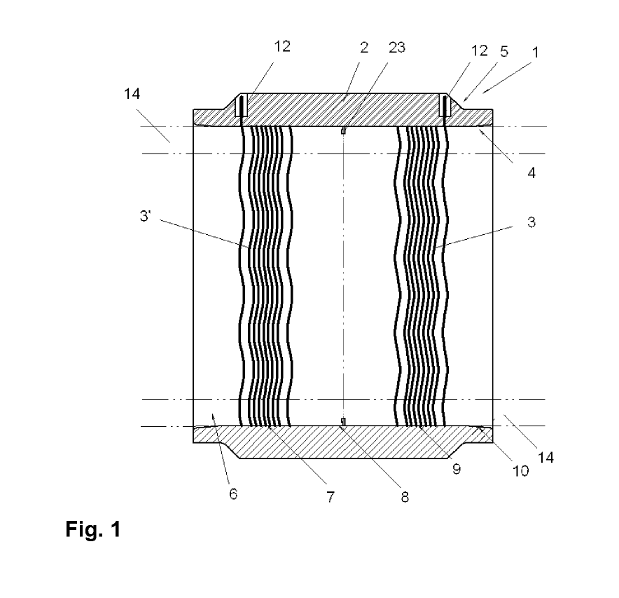

FIG. 1 shows a longitudinal section of a heating coil welding fitting 1 for connecting plastic pipeline components. The heating coil welding fitting 1 contains a sleeve 2 which is produced from a weldable thermoplastic. A respective pipeline section 14 is inserted on both sides into the inside diameter of the sleeve 2 in order to subsequently tightly weld the pipeline sections 14 to the heating coil welding fitting 1. The longitudinal axes of the two fitted-together pipeline sections 14 and the longitudinal axis of the heating coil welding fitting 1 are in alignment with one another. However, heating coil welding fittings 1 in which the connection pieces are arranged at a certain angle to one another, for example 60°, 90°, 120°, etc., are also conceivable. A further embodiment is a sleeve having different inside diameters on both sides, which enables two different pipeline cross sections to be fitted together. A combination of the two embodiments is likewise conceivable. Furthermore, heating coil welding fittings which have more than two connection openings can also be produced, for example Y-shaped or T-shaped heating coil welding fittings.

The heating coil welding fitting 1 is divided into different annular zones along the longitudinal axis. Arranged on the outer side of the heating coil welding fitting 1 is the cold zone 6, following which is the welding zone 7, in which the heating wire of the wavy winding 3′ runs. Located in the centre of the fitting 1 is the cold zone 8, which is arranged between the two windings 3, 3′. This is followed by the welding zone 9, following which is a final cold zone 10.

Such a division into the different zones results in an optimum pressure distribution of the heating coil welding fitting 1 over the pipelines during the welding operation. During the heating of the heating coil welding fitting 1, the volume of the melting plastic of the sleeve 2 and of the pipeline in the region of the welding zones 7, 9 increases and flows into the region of the cold zones 6, 8 10, where it then solidifies and as a result dams the subsequently flowing plastic and thus causes a pressure increase in the welding zone 7, 9.

The inserted pipeline sections 14 can be pushed towards one another right into the centre of the heating coil welding fitting 1. It is also possible to provide studs in the centre of the heating coil welding fitting 1, said stud serving as a stop 23 for the pipeline sections 14. It is thus ensured that both pipeline sections 14 have been inserted sufficiently deeply into the heating coil welding fitting 1.

On the outer circumference, the sleeve 2 has a bevel 5 at each end for reducing the outside diameter, as a result of which the elasticity is increased and the pushing-in of the corresponding pipeline is simplified.

A chamfer 4 for facilitating the insertion of the pipeline sections 14 is provided at each connection opening.

Close to the inside diameter of the heating coil welding fitting 1, heating wires are wound on to form two windings 3, 3′ which serve to heat the plastic and therefore permit the welding of the heating coil welding fitting 1 and the pipeline sections 14. The heating wires have been encapsulated in the sleeve, ploughed into the sleeve, inserted into the sleeve or put into the sleeve 2 by another method.

In the normal case, the heating wire windings 3, 3′ run in a continuous or curved manner 3′ or in a discontinuous or zigzag-like manner 3 in an electric welding sleeve or nipple, a combination as depicted in FIG. 1 also being feasible.

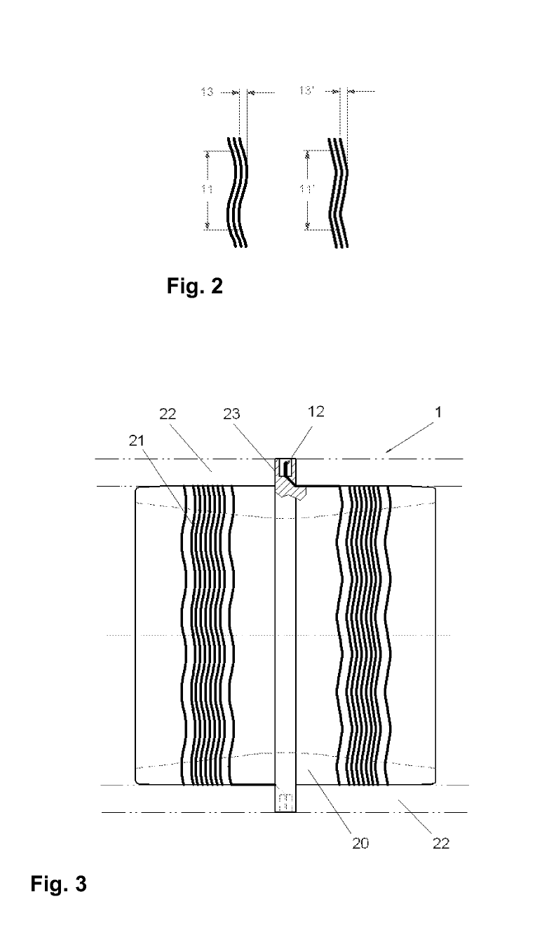

The heating wires are wound on in wavy lines 3, 3′ at a slight distance from the inside diameter of the sleeve 2. A cycle 11, 11′ of the wavy wire, which is shown in FIG. 2, repeats itself periodically along the spiral heating wire 3, 3′. The heating wire can have any desired pitch, which can be both constant and variable; for example, during a winding, the pitch is first small and then increases and decreases again towards the end.

The deflection 13, 13′ or the amplitude of the winding is likewise freely selectable and is usually adapted to the application and the diameter, although a maximum value of 10 mm should not be exceeded. In most cases there are between six and twelve cycles 11, 11′ of the wavy winding per turn, this depending on the diameter of the heating coil welding fitting 1 or on the diameter of the pipeline section 14.

Owing to the fact that the heating wires are attached in a wavy manner in the heating coil welding fitting 1, this makes the heating coil welding fitting 1 deformable; that is to say, it is possible to contract the heating coil welding fitting 1 and to clamp it onto the outside diameter of the pipeline component, for example by a separate clamping tool or clamping set which is placed around the heating coil welding fitting 1 and is thus clamped onto the pipeline section 14, such that the gap between the heating coil welding fitting 1 and the pipeline section 14 is eliminated, thereby providing optimum conditions for welding the components. A further advantage of this type of heating wire winding 3, 3′ consists in the fact that the linear expansion of the heating wire is distributed over the individual cycles 11, 11′ and is not concentrated, as in straight-wound windings, at the location at which the least resistance prevails, as a result of which the entire elongation of the wire is concentrated at one point and the heating wire consequently passes through the outer layer of the inside diameter of the sleeve 2, thereby causing a wire to emerge undesirably. As a result of the wavy arrangement, the elongation is distributed to the individual cycles 11, 11′ and the heating wire is thereby not stretched at any location to such an extent that it emerges from the plastic. The wavy, preferably sinusoidal, heating wire winding 3, 3′ can be produced both with curves, that is to say continuously 3′, and with a heating wire laid in an angular, zigzag-like manner, that is to say discontinuously 3. A voltage is applied to the heating wire winding 3, 3′ via the contacts 12.

FIG. 3 shows heating wire windings 21 which are located on an outside diameter of a nipple 20. In such an embodiment, the pipeline section 22 is pushed onto the nipple 20 and then welded. Owing to the fact that the heating wire winding 21 is wavy, the nipple 20, in order to be inserted into the pipeline sections 22, can be compressed and widens again in the fitted state. The outside diameter of the nipple 20 consequently presses against the inside diameter of the pipeline sections 22, which constitutes an optimum precondition for the heat transfer.

The nipples can also be produced in embodiments in which more than two pipeline sections can be connected, such as, for example, Y-shaped or T-shaped nipples. Furthermore, connections at angles, e.g. 45°, 60°, 120°, etc., are also conceivable here, and different pipe diameters can be adapted to the same nipple, in which the individual outlets of the nipple have different diameters.

1. A heating coil welding fitting comprising a cylindrical coupling body for welding pipelines made of weldable plastics, having at least two heating wire windings, each with a plurality of turns which are at any desired distance from one another, and contacts for feeding the electric current, wherein the heating wire winding is wavy, and the coupling can be deformed as a result.

2. A heating coil welding fitting according to claim 1, wherein the heating wire winding is sinusoidal.

3. A heating coil welding fitting according to claim 1, wherein the heating coil welding fitting has a stop for controlling the position of the pipeline sections.

4. A heating coil welding fitting according to claim 2, wherein the heating coil welding fitting is for pipe diameters over 250 mm.

5. A heating coil welding fitting according to claim 1, wherein a deflection of the heating wire winding is not greater than 10 mm.

6. A heating coil welding fitting according to claim 1, wherein the distances between the turns are constant or the pitch of the heating wire winding is constant.

7. A heating coil welding fitting according to claim 1, wherein the distances between the windings are variable or the pitch of the heating wire winding is variable during a winding.

8. A heating coil welding fitting according to claim 1, wherein six to twelve cycles are arranged along a turn of the heating wire winding.

9. A heating coil welding fitting according to claim 1, wherein the wavy heating wire winding runs in a continuous or curved manner.

10. A heating coil welding fitting according to claim 1, wherein the wavy heating wire winding runs in a discontinuous or zigzag-like manner.

11. A heating coil welding fitting according to claim 1, wherein the heating wire winding is arranged on the inside diameter of an electric welding sleeve.

12. A heating coil welding fitting according to claim 1, wherein the heating wire winding is arranged on an outside diameter of a nipple.
